(19) United States
(12) Patent Application Publication
(10) Pub. No.: US 2020/0279172 A1
(43) Pub. Date: Sep. 3, 2020

(54) INFORMATION PROCESSING APPARATUS AND NON-TRANSITORY COMPUTER READABLE MEDIUM STORING PROGRAM

(71) Applicant: FUJI XEROX CO., LTD., TOKYO (JP)

(72) Inventors: Yoko OTA, Kanagawa (JP); Kazunari HASHIMOTO, Kanagawa (JP); Seiya INAGI, Kanagawa (JP); Masao WATANABE, Kanagawa (JP)

(73) Assignee: FUJI XEROX CO., LTD., TOKYO (JP)

(21) Appl. No.: 16/517,659

(22) Filed: Jul. 21, 2019

(30) Foreign Application Priority Data
Mar. 1, 2019 (JP) 2019-037285

(51) Int. Cl. G06N 5/02; G06F 16/335; G06F 17/27; G06F 16/338

(52) U.S. Cl. CPC G06N 5/022; G06F 16/338; G06F 17/2705; G06F 16/337

(57) ABSTRACT

An information processing apparatus includes a segment obtaining section that obtains a segment described in a document designated by a user, an extraction condition obtaining section that obtains an extraction condition for extracting information including a concept related to the segment as knowledge information from a concept structure information storage section storing concept structure information in which concepts representing events and relationships related to knowledge are related to each other in a hierarchical structure, a specifying section that specifies a storage location of the knowledge information in the concept structure information storage section and an extraction method for the concept included in the knowledge information from a designated content of the extraction condition, an extraction section that extracts the knowledge information in accordance with the specified extraction method from the storage location specified by the specifying section, and a presentation section that presents the knowledge information to the user.

### CROSS-REFERENCE TO RELATED APPLICATIONS

This application is based on and claims priority under 35 USC 119 from Japanese Patent Application No. 2019-037285 filed Mar. 1, 2019.

### BACKGROUND

### (i) Technical Field

The present invention relates to an information processing apparatus and a non-transitory computer readable medium storing a program.

### (ii) Related Art

There is knowledge that a user has to have in the case of reading, for example, a professional book requiring professional knowledge, or knowledge that facilitates understanding of the content of the professional book in a case where the user has the knowledge. However, in many cases, such knowledge is usually personal knowledge and know-how of professionals. In recent years, information in which concepts representing events, relationships, and the like related to knowledge are related to each other in a hierarchical structure is stored in a database so that the personal knowledge and the like of the professionals may be effectively used. For example, in recent years, a database based on a concept of a knowledge graph is developed.

JP2017-182457A and JP2018-005690A are examples of the related art.

### SUMMARY

In order to use information based on knowledge stored in a database, a user has to know the location where the information is stored in the database and the way of extracting the information.

Aspects of non-limiting embodiments of the present disclosure relate to an information processing apparatus and a non-transitory computer readable medium storing a program extracting information matching an extraction condition designated by a user and presenting the information to the user even in a case where the user does not know a storage location and an extraction method of information related to a document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a segment obtaining section that obtains a segment described in a document designated by a user, an extraction condition obtaining section that obtains an extraction condition for extracting information including a concept related to the segment as knowledge information from a concept structure information storage section storing concept structure information in which concepts representing events and relationships related to knowledge are related to each other in a hierarchical structure, a specifying section that specifies a storage location of the knowledge information in the concept structure information storage section and an extraction method for the concept included in the knowledge information from a designated content of the extraction condition, an extraction section that extracts the knowledge information in accordance with the specified extraction method from the storage location specified by the specifying section, and a presentation section that presents the knowledge information to the user.

### BRIEF DESCRIPTION OF THE DRAWINGS

Exemplary embodiment(s) of the present invention will be described in detail based on the following figures, wherein:

FIG. 1 is a block configuration diagram illustrating an information processing apparatus according to one exemplary embodiment of the present invention;

FIG. 2 is a conceptual diagram illustrating a data structure of a knowledge graph handled in the present exemplary embodiment;

FIG. 3 is a flowchart illustrating a process of providing the knowledge graph to a user in the present exemplary embodiment;

FIG. 4 is a conceptual diagram illustrating a process of extracting a single word from a document in the present exemplary embodiment;

FIG. 5 is a conceptual diagram illustrating a category label assigning process in the present exemplary embodiment;

FIG. 6 is a conceptual diagram illustrating a supporting knowledge extraction process in the present exemplary embodiment;

FIG. 7 is a conceptual diagram illustrating a KG extraction method selection process in the present exemplary embodiment;

FIG. 8 is a flowchart illustrating a KG extraction process in the present exemplary embodiment;

FIG. 9 is a conceptual diagram illustrating a structure of a knowledge graph selected in the present exemplary embodiment;

FIG. 10 is a diagram illustrating a progress of extraction of knowledge information to be presented to the user in the present exemplary embodiment;

FIG. 11 is a diagram illustrating the progress of extraction of the knowledge information to be presented to the user in the present exemplary embodiment;

FIG. 12 is a diagram illustrating the progress of extraction of the knowledge information to be presented to the user in the present exemplary embodiment;

FIG. 13 is a diagram illustrating the progress of extraction of the knowledge information to be presented to the user in the present exemplary embodiment;

FIG. 14 is a diagram illustrating the progress of extraction of the knowledge information to be presented to the user in the present exemplary embodiment;

FIG. 15 is a diagram illustrating the progress of extraction of the knowledge information to be presented to the user in the present exemplary embodiment;

FIG. 16 is a diagram illustrating the progress of extraction of the knowledge information to be presented to the user in the present exemplary embodiment;

FIG. 17 is a diagram illustrating the knowledge information to be presented to the user in a graph format in the present exemplary embodiment; and

FIG. 18 is a diagram representing the knowledge information illustrated in FIG. 17 in a sentence format.

### DETAILED DESCRIPTION

Hereinafter, an exemplary embodiment of the present invention will be described based on the drawings.

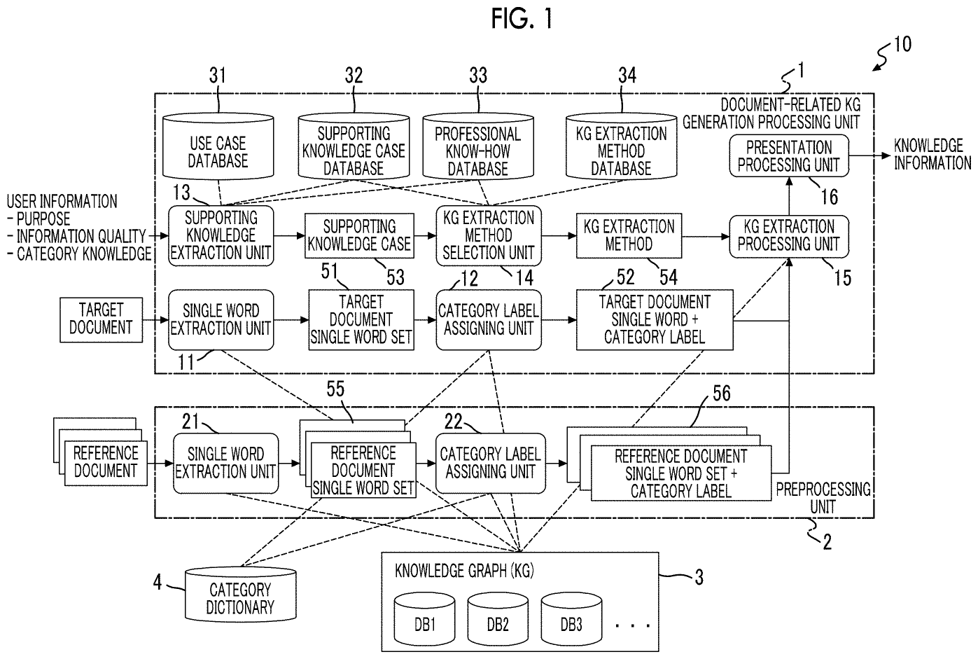

FIG. 1 is a block configuration diagram illustrating an information processing apparatus according to one exemplary embodiment of the present invention. An information processing apparatus 10 in the present exemplary embodiment may be implemented using a general-purpose personal computer (PC). That is, the information processing apparatus 10 includes a CPU, a ROM, a RAM, and a storage section such as a hard disk drive (HDD). In addition, the information processing apparatus 10 needs to exchange information with a user. Thus, the information processing apparatus 10 may include a user interface such as a mouse and a keyboard as an input section and a display as a display section. In the case of exchanging information through a network, the information processing apparatus 10 may include a network interface as a communication section.

The information processing apparatus 10 in the present exemplary embodiment includes a document-related KG generation processing unit 1, a preprocessing unit 2, a knowledge graph (KG) 3, and a category dictionary 4. Constituents not used in the description of the present exemplary embodiment are not illustrated in FIG. 1. The present exemplary embodiment uses a knowledge graph. First, the knowledge graph will be described.

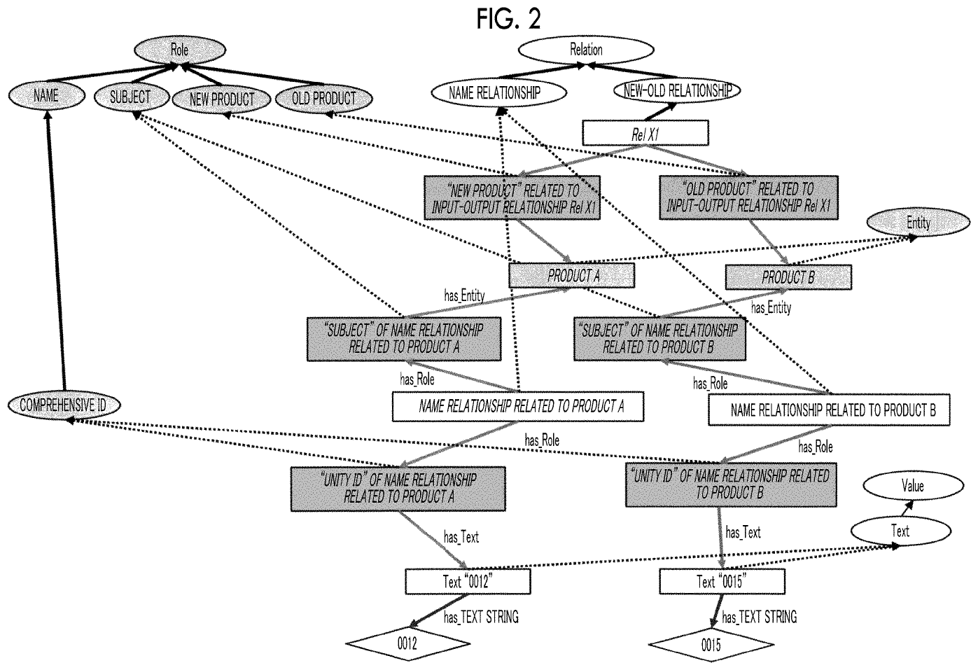

FIG. 2 is a conceptual diagram illustrating a data structure of the knowledge graph. The “knowledge graph” is defined as a concept and the like representing events, relationships, and the like related to knowledge and represents structured concepts (in FIG. 2, information represented by ellipses and rectangles) as illustrated in FIG. 2. More specifically, the knowledge graph is a graph representing a structure of concepts based on semantic relationships of an entity, a relation, a role, and a value. The entity means an object or an event in a broad sense. The relation means a relationship between objects and events. That is, the relation indicates the relationship between entities in the representation of knowledge. The role means a role of an object or an event in the relationship between objects and events. That is, the role indicates the relationship between entities in the relation and also the roles of the entities. The value is a value indicating an object or an event and is represented by a text string or a numerical value. FIG. 2 illustrates an input-output relationship between a product A having a unity ID “0012” and a product B having a unity ID “0015”.

The knowledge graph 3 is a database storing concept structure information in which concepts representing events and relationships related to knowledge are related to each other in a hierarchical structure. The knowledge graph 3 generally stores various knowledge bases. The “knowledge base” is a database in which knowledge is described based on a specific representation format. The knowledge base corresponds to DB1, DB2, and the like included in the knowledge graph 3 illustrated in FIG. 1. In addition, each knowledge base constitutes the knowledge graph 3 and thus, may also be a knowledge graph. The knowledge graph represents concepts in a resource description framework (RDF) format. In the present exemplary embodiment, the term “knowledge graph” is used in the meaning of the structured information illustrated in FIG. 2 or a knowledge database. In the case of referring to a knowledge graph stored in a database, that is, a configuration included in the information processing apparatus 10, the “knowledge graph 3” designated by a reference sign will be used.

In the present exemplary embodiment, knowledge information that is formed by extracting concepts matching user information (user information corresponds to an extraction condition for the knowledge information) designated by the user and a structural relationship between the extracted concepts from the knowledge graph 3 is presented to the user. The knowledge information presented to the user is formed by partial extraction from the knowledge base included in the knowledge graph 3 and thus, is also a knowledge graph. In FIG. 2, the relationship between concepts is indicated by an arrow. The arrow indicates the structural relationship between concepts.

The document-related KG generation processing unit 1 executes a basic process for presenting the knowledge graph (that is, the knowledge information) customized for the user by extracting information from the knowledge graph 3, more specifically, by obtaining a part of information defined in the knowledge base based on a segment included in a document designated by the user. The preprocessing unit 2 provides additional information in the generation of the knowledge information by the document-related KG generation processing unit 1. The category dictionary 4 stores a type of category indicating the industry, the field, and the like and typically used by the user, and information (for example, a material name) related to the category.

The document-related KG generation processing unit 1 includes a single word extraction unit 11, a category label assigning unit 12, a supporting knowledge extraction unit 13, a KG extraction method selection unit 14, a KG extraction processing unit 15, a presentation processing unit 16, a use case database (DB) 31, a supporting knowledge case database (DB) 32, a professional know-how database (DB) 33, and a KG extraction method database (DB) 34.

The single word extraction unit 11 functions as a segment obtaining section and obtains a single word described in the document designated by the user. The “segment” means a word or a phrase. Not only a word (having the same meaning as the “single word”) but also a phrase may be obtained by extraction from the document. In the present exemplary embodiment, a case of extracting the single word will be illustratively described. The category label assigning unit 12 functions as a category linking section and links a category to which the single word belongs to each single word obtained by the single word extraction unit 11 by referring to the category dictionary 4. The supporting knowledge extraction unit 13 functions as an extraction condition obtaining section and obtains the user information input and designated by the user. The user information in the present exemplary embodiment corresponds to the extraction condition for extracting information including a concept related to the single word extracted from the document as the knowledge information from the knowledge graph 3.

The KG extraction method selection unit 14 functions as a specifying section and specifies a storage location of the knowledge information in the knowledge graph 3 and an extraction method (in a strict sense, an extraction method for concepts included in the knowledge information) for the knowledge information from the designated content of the extraction condition. The KG extraction processing unit 15 functions as an extraction section and extracts the knowledge information in accordance with the specified extraction method from the storage location specified by the KG extraction method selection unit 14. The presentation processing unit 16 presents the knowledge information extracted by the KG extraction processing unit 15 to the user. As will be described in detail, the knowledge information may be presented in a graph format or a sentence format in the present exemplary embodiment.

The content of data registered in each of the databases 31 to 34 will be described along with a description of processes.

The preprocessing unit 2 includes a single word extraction unit 21 and a category label assigning unit 22. The single word extraction unit 21 and the category label assigning unit 22 have the same processing functions as the single word extraction unit 11 and the category label assigning unit 12 of the document-related KG generation processing unit 1.

The category dictionary 4 stores category information in which segments and categories are associated with each other in advance.

Each of the constituents 11 to 16, 21, and 22 in the information processing apparatus 10 is implemented by a cooperative operation between a computer forming the information processing apparatus 10 and a program operated by a CPU mounted in the computer. In addition, each of the storage sections 3, 4, and 31 to 34 is implemented in an HDD mounted in the information processing apparatus 10. Alternatively, a RAM or an external storage section may be used through a network.

In addition, the program used in the present exemplary embodiment may be provided by a communication section and may also be provided by storing the program in a computer readable recording medium such as a CD-ROM and a USB memory. The program provided from the communication section or the recording medium is installed on the computer. The CPU of the computer implements various processes by executing the program in order.

For example, when the user of the information processing apparatus 10 in the present exemplary embodiment reads a professional book, the user may not understand the content of the professional book due to insufficient professional knowledge in the professional field. Even in a case where the user desires to obtain knowledge necessary for understanding, the necessary knowledge may be professional knowledge and generally know-how of a professional. Even in a case where the knowledge is stored as information in a database such as the knowledge graph 3 of the present exemplary embodiment, the location where necessary information is stored in the database and the way of extracting the information may not be known without knowledge of handling the database.

Therefore, in the present exemplary embodiment, knowledge such as the know-how of the professional is accumulated in the knowledge graph 3 and may be used by the user. Information necessary for the user may be presented as the knowledge information without knowing the location where the information necessary for the user is stored in the knowledge graph 3 and the way of extracting the information from the storage location.

Furthermore, in the present exemplary embodiment, the information necessary for the user is not presented as a uniform content. The information necessary for the user may be presented as a content corresponding to the purpose of the user and a level matching a knowledge level specified from the user information designated by the user.

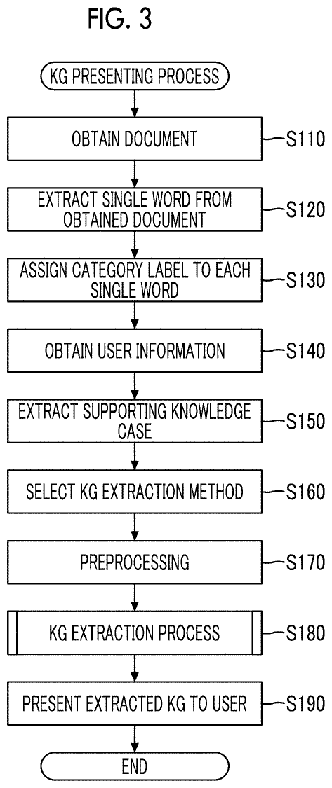

Hereinafter, a process of presenting the knowledge graph (that is, the knowledge information) necessary for the user in the present exemplary embodiment will be described using the flowchart illustrated in FIG. 3. The process will be described on assumption that the knowledge graph 3 in the present exemplary embodiment stores information related to material as the knowledge base.

In a case where the user inputs a document (professional book illustrated above; corresponds to a target document illustrated in FIG. 1) as a processing target, the information processing apparatus 10 obtains the document (step S110). The “document” is computerized document data. The document does not need to be composed of only texts and may include images such as drawings. In the following description, the document as a processing target (target document illustrated in FIG. 1) will be simply referred to as the “document”.

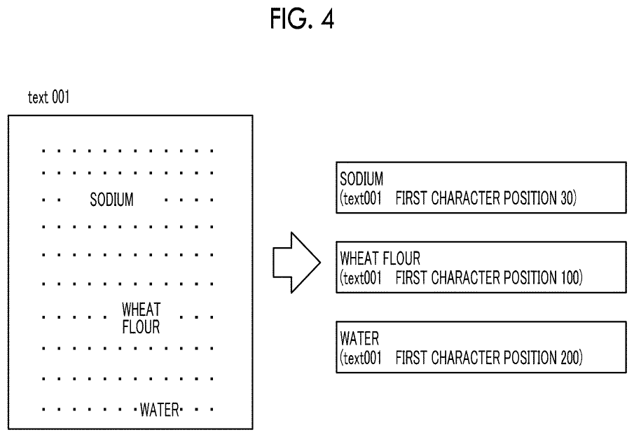

In a case where the document is obtained, the single word extraction unit 11 extracts single words from the obtained document (step S120). It is assumed that single words related to material for which information is registered in the knowledge graph 3 are extracted. A summary of a process of extracting the single words is illustrated in FIG. 4.

The single word extraction unit 11 extracts texts indicating material by referring to the knowledge graph 3 and extracts single words matching the extracted texts. The single word extraction unit 11 further extracts a document name of the document in which the extracted single words (in FIG. 4, “sodium”, “wheat flour”, and “water”) are described, and information related to the position of the description in the document. The single word extraction unit 11 generates information by adding the document name and the position of the description to the single words. The generated information corresponds to a target document single word set 51 illustrated in FIG. 1.

While the single words are extracted from the document in the present exemplary embodiment, the single words may be extracted using sentences included in the range of a part of the document such as a range designated by the user as a target and not using the whole document as a target. For example, a text area for copying sentences is disposed in a separate window, and a part of the sentences copied in the text area is used as a target of the single word extraction. In addition, while the single word extraction unit 11 automatically extracts corresponding single words, the user may designate the single words.

In a case where the single word extraction unit 11 extracts the single words, next, the category label assigning unit 12 assigns a category label to each single word (step S130).

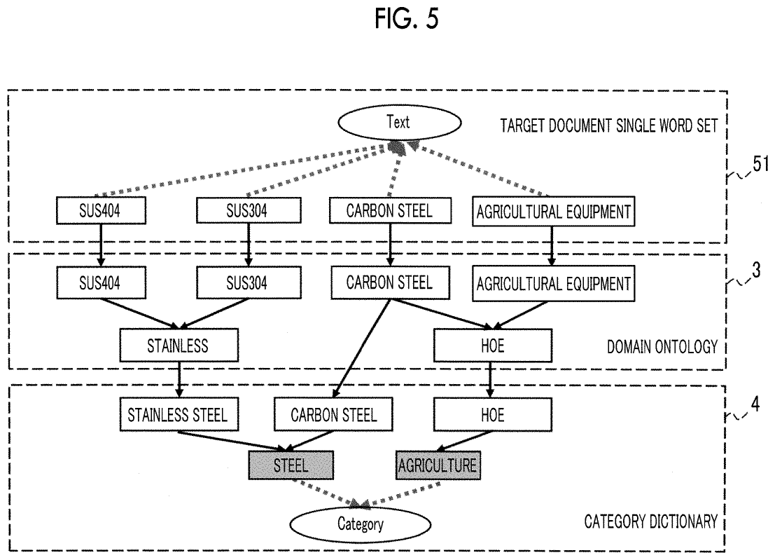

FIG. 5 is a conceptual diagram illustrating a category label assigning process executed by the category label assigning unit 12. The category label assigning unit 12 assigns the category label to each single word by associating each single word extracted from the document with the category defined in the category dictionary 4. In the present exemplary embodiment, linking the category to the single word is referred to as assigning the category label to the single word. FIG. 5 illustrates an example in which the single word extraction unit 11 extracts “SUS404”, “SUS304”, “carbon steel”, and “agricultural equipment” as single words. In the category dictionary 4, “steel” and “agriculture” are set as categories. In addition, “stainless steel” and “carbon steel” are linked as related terms representing the category “steel”, and “hoe” is linked as a related term representing the category “agriculture”.

The knowledge graph 3 includes a domain ontology describing concepts related to individual target areas (that is, categories). The category is linked to the single word using the domain ontology. Information in which the category label is assigned to each single word in the above manner corresponds to a target document single word set+category label 52 illustrated in FIG. 1.

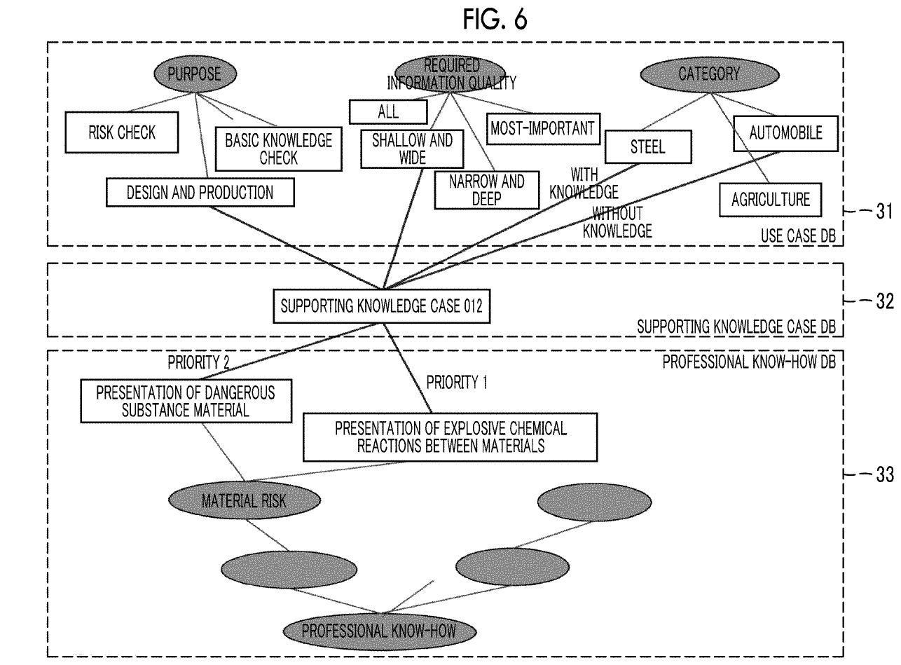

In a case where the user inputs the document, the supporting knowledge extraction unit 13 then causes the user to designate the user information. The designated user information is information including concepts related to the single words extracted by the single word extraction unit 11, that is, the extraction condition for the knowledge information to be presented to the user. In the present exemplary embodiment, a case where the user designates items of “purpose”, “required information quality”, and “category” as the extraction condition for the knowledge information is considered. FIG. 6 is a conceptual diagram illustrating a supporting knowledge extraction process executed by the supporting knowledge extraction unit 13. In the use case database 31 illustrated in FIG. 6, the structure of information related to the items is defined. The item “purpose” is the purpose of performing information search. The item “required information quality” is a quality required for obtained information. The item “category” includes a category in which the user has sufficient knowledge as the background of the user and a category in which the user does not have sufficient knowledge.

The supporting knowledge extraction unit 13 displays concepts (“risk check” and the like in “purpose”, “all” and the like in “required information quality”, and “steel” and the like in “category”) related to each item set in the use case database 31 on a screen as selection candidates. The user selects item values matching the purpose and the like of the user for each concept from the displayed item values. Thus, the user information is said to be information indicating a relationship between the user and the target document. The supporting knowledge extraction unit 13 obtains the user information by causing the user to select the item values (step S140). The user information designated by the user is the extraction condition for the knowledge information. In a strict sense, the user information is the extraction condition for concepts included in the knowledge information. Thus, in the following description, the obtained user information will be referred to as the “extraction condition for the knowledge information” or simply the “extraction condition”.

Next, the supporting knowledge extraction unit 13 extracts a supporting knowledge case corresponding to the extraction condition designated by the user from supporting knowledge cases registered in the supporting knowledge case database 32 (step S150). In order to present the user with concepts matching the extraction condition designated by the user, it is necessary to clarify the target of search. In the supporting knowledge case, knowledge association information in which the extraction condition designated by the user is associated with the target of search and an action for the search is defined. The action corresponds to the extraction method for the knowledge information. The professional know-how database 33 illustrated in FIG. 6 stores the extraction method (that is, the action) for concepts (concepts included in the knowledge information to be presented to the user) matching the designated extraction condition from the knowledge graph 3. For example, “presentation of dangerous substance material” in FIG. 6 defines an action of presenting information related to knowledge related to dangerous substance material to the user. In other words, an extraction method of extracting concepts related to dangerous substance material is defined for extracting concepts matching the extraction condition.

FIG. 6 illustrates a case where the user designates “design and production” in “purpose”, “shallow and wide” in “required information quality”, and “steel” as knowledge that the user has and “automobile” as knowledge that the user does not have in “category” as the user information. Plural supporting knowledge cases corresponding to combinations of the items registered in the use case database 31 are registered in the supporting knowledge case database 32. The supporting knowledge extraction unit 13 extracts a supporting knowledge case (in FIG. 6, a “supporting knowledge case 012”) corresponding to the extraction condition designated by the user from the supporting knowledge case database 32. The extracted “supporting knowledge case 012” corresponds to a supporting knowledge case 53 in FIG. 1.

As described thus far, the supporting knowledge extraction unit 13 extracts the supporting knowledge case corresponding to the extraction condition designated by the user. By extracting the supporting knowledge case, the supporting knowledge extraction unit 13 specifies the action for the way of extracting concepts included in the knowledge information, in other words, the concepts to be extracted and included in the knowledge information, based on the extraction condition from the professional know-how database 33.

As illustrated in FIG. 6, in a case where plural actions to be linked are present, a priority is set for each action. A standard for setting the priority is defined in the supporting knowledge case.

According to the setting example illustrated in FIG. 6, the supporting knowledge extraction unit 13 links actions “presentation of explosive chemical reactions between materials” and “presentation of dangerous substance material” to each other by extracting the supporting knowledge case (in the example, the “supporting knowledge case 012”) from the setting contents (“design and production” in “purpose” and the like) of the user information. That is, this process obtains the extraction method for the knowledge information such that information that is related to explosive chemical reactions between materials and has a higher priority between the extracted actions is extracted first, and information related to dangerous substance material is extracted next.

The extracted supporting knowledge case varies depending on the item values included in the user information by the user. Accordingly, the contents and the number of extracted actions may vary, and the priority of each action may vary even in a case where the same actions are extracted.

By extracting the supporting knowledge case 53, the supporting knowledge extraction unit 13 specifies that it is necessary to search for knowledge to be presented to the user, that is, professional knowledge and know-how to be searched by the user such as knowledge (referred to as “information”) related to explosive chemical reactions between materials and dangerous substance material in the above example. Next, the KG extraction method selection unit 14 selects a KG extraction method for linking the knowledge to be searched to the knowledge case included in the knowledge graph 3 as the storage location of the knowledge (step S160).

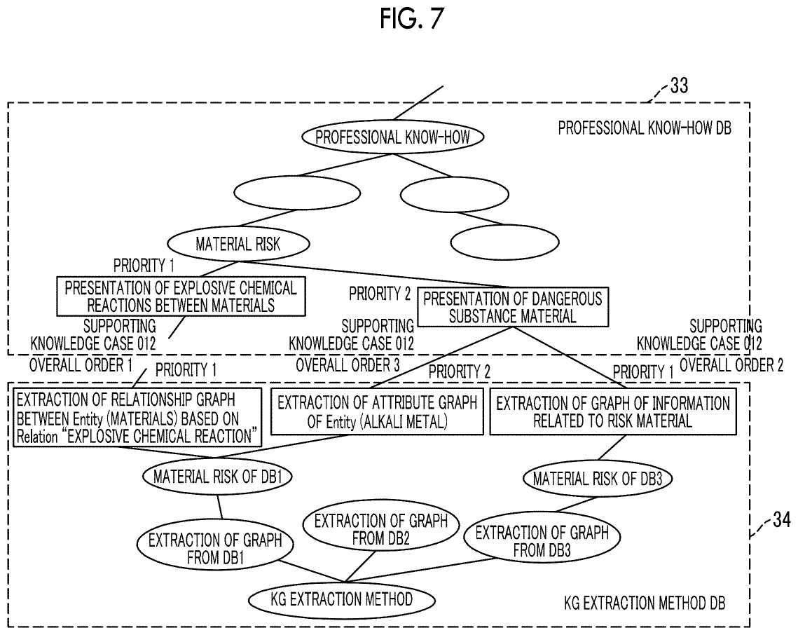

FIG. 7 is a conceptual diagram illustrating a KG extraction method selection process executed by the KG extraction method selection unit 14. The KG extraction method database 34 stores knowledge information extraction information in which the extraction method for the knowledge information is associated with the knowledge base as an extraction location of concepts based on the extraction method, that is, the knowledge base as the storage location of the concepts (candidates of concepts included in the knowledge information). The KG extraction method selection unit 14 specifies the storage location of the knowledge information in the knowledge graph 3 by referring to the supporting knowledge base specified based on the extraction condition by the supporting knowledge extraction unit 13, the professional know-how database 33, and the KG extraction method database 34.

First, the KG extraction method selection unit 14 recognizes that “presentation of explosive chemical reactions between materials” is earlier than “presentation of dangerous substance material” in a search order (that is, the order of actions to be executed) by referring to the extracted supporting knowledge case 53. Two KG extraction methods are linked to “presentation of dangerous substance material”. Priority orders are set from the information defined in the KG extraction methods. FIG. 7 illustrates the search order (“overall order”).

According to the data structure of the KG extraction method database 34 illustrated in FIG. 7, in order to obtain knowledge related to “presentation of explosive chemical reactions between materials” having the highest priority, it may be specified that information related to “extraction of relationship graph between entities (materials) based on relation “explosive chemical reaction”” stored in the knowledge graph 3 is to be obtained, and this information is included in DB1 of the knowledge graph 3. Next, in order to obtain knowledge related to “presentation of dangerous substance material”, it is defined that information related to “extraction of graph of information related to risk material” having the second highest priority is to be obtained, and this information may be extracted from DB3 of the knowledge graph 3. Next, it is defined that information related to “extraction of attribute graph of entity (alkali metal)” having the third highest priority is to be obtained, and this information may be extracted from DB1 of the knowledge graph 3. Accordingly, in a case where the knowledge graph 3 stores plural knowledge bases (DB1 and the like), the KG extraction method selection unit 14 specifies the knowledge base including the knowledge information matching the extraction condition.

The KG extraction method selection unit 14 specifies the knowledge base including concepts necessary for generating the knowledge information, that is, the storage location of the knowledge information, by referring to the KG extraction method database 34. In addition, the priority order of the knowledge base is specified considering both the priority order set in the professional know-how database 33 and the priority order set in the KG extraction method. The KG extraction method including the storage location and the storage method of the generated knowledge information and the priority order of the knowledge base corresponds to a KG extraction method 54 illustrated in FIG. 1.

The preprocessing unit 2 includes the single word extraction unit 21 and the category label assigning unit 22 equivalent to the single word extraction unit 11 and the category label assigning unit 12 of the document-related KG generation processing unit 1. Accordingly, in order for the document-related KG generation processing unit 1 to generate the target document single word+category label 52 from the target document, the preprocessing unit 2 performs preprocessing of generating a reference document single word set 55 from a reference document and generating a reference document single word set+category label 56 (step S170). For example, the “reference document” is desirably a professional book belonging to the same professional field as the target document. Plural professional books may be set as the reference document.

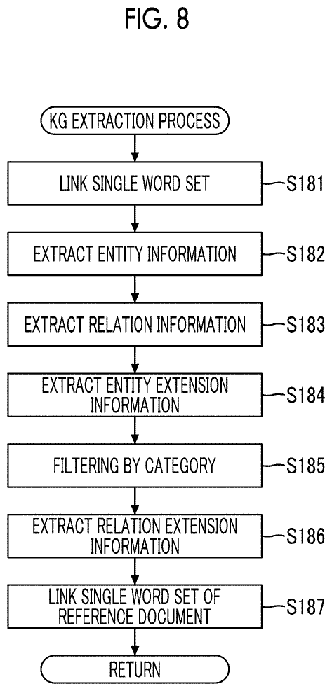

In a case where the storage location, in other words, the knowledge base (DB1 and the like in the above example) of the knowledge information to be presented to the user in the knowledge graph 3 is specified in the above manner, the KG extraction processing unit 15 executes a KG extraction process of extracting concepts included in the knowledge information to be presented to the user from the storage location (step S180). That is, in a case where the user inputs the document and the user information (that is, the extraction condition for the knowledge information), the KG extraction processing unit 15 automatically extracts information (that is, information matching the extraction condition for the knowledge information) considered to be necessary for the user from the large size knowledge graph 3 and presents the information to the user. Hereinafter, details of the KG extraction process performed by the KG extraction processing unit 15 in the present exemplary embodiment will be described using the flowchart illustrated in FIG. 8.

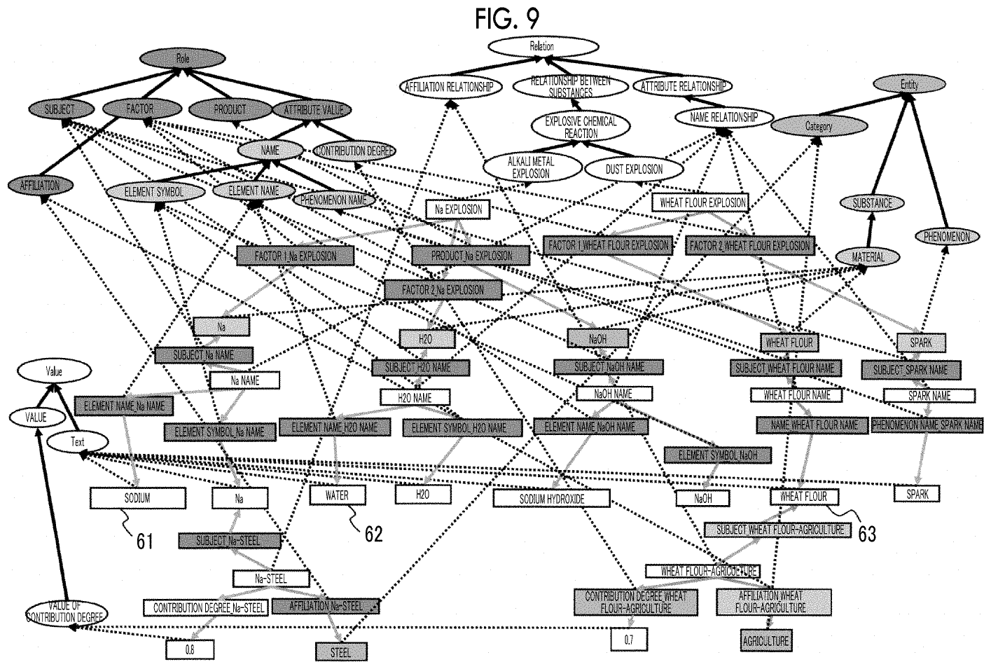

First, the structure of the knowledge graph 3 used in the description of the KG extraction process is illustrated in FIG. 9. A case where the single word extraction unit 11 extracts single words, that is, texts “sodium”, “water”, and “wheat flour”, will be illustratively described.

In step S160, the KG extraction method selection unit 14 selects “extraction of relationship graph between entities (materials) based on relation “explosive chemical reaction”” as the KG extraction method having the highest priority order. FIG. 9 illustrates a knowledge graph (that is, a knowledge base DB1) related to “extraction of relationship graph between entities (materials) based on relation “explosive chemical reaction”” included in DB1 and selected by the KG extraction method selection unit 14. Information related to the single words, that is, texts, “sodium” 61, “water” 62, and “wheat flour” 63 extracted from the target document is included. The KG extraction processing unit 15 decides and extracts a range, that is, information, to be presented to the user from the knowledge graph illustrated in FIG. 9. In the present exemplary embodiment, as will be described below, concepts included in the knowledge information are extracted by referring to the entity, the relation, and the role indicating a semantic relationship. However, at least one of the entity, the relation, or the role may be referred to.

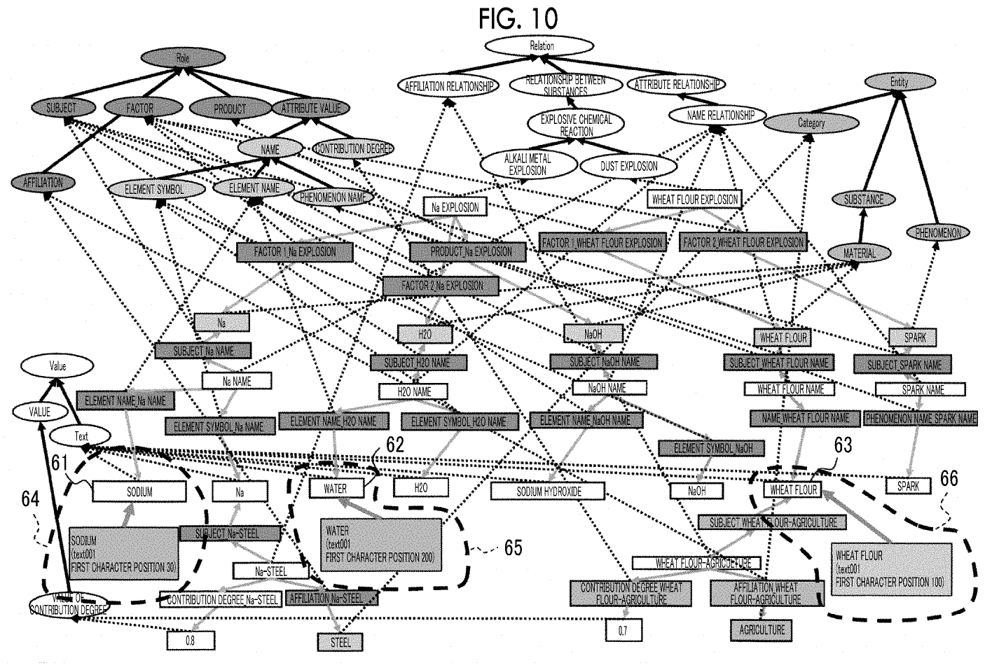

First, as illustrated by enclosures with broken lines 64, 65, and 66 in FIG. 10, the KG extraction processing unit 15 extracts each text, that is, a text information instance (that is, a single word set) corresponding to each single word constituting the single word set included in the target document single word set+category label 52, and links the texts 61, 62, and 63 to the corresponding single words (step S181). In FIG. 10 to FIG. 17 illustrated below, the structure of the same knowledge graph as FIG. 9 is illustrated.

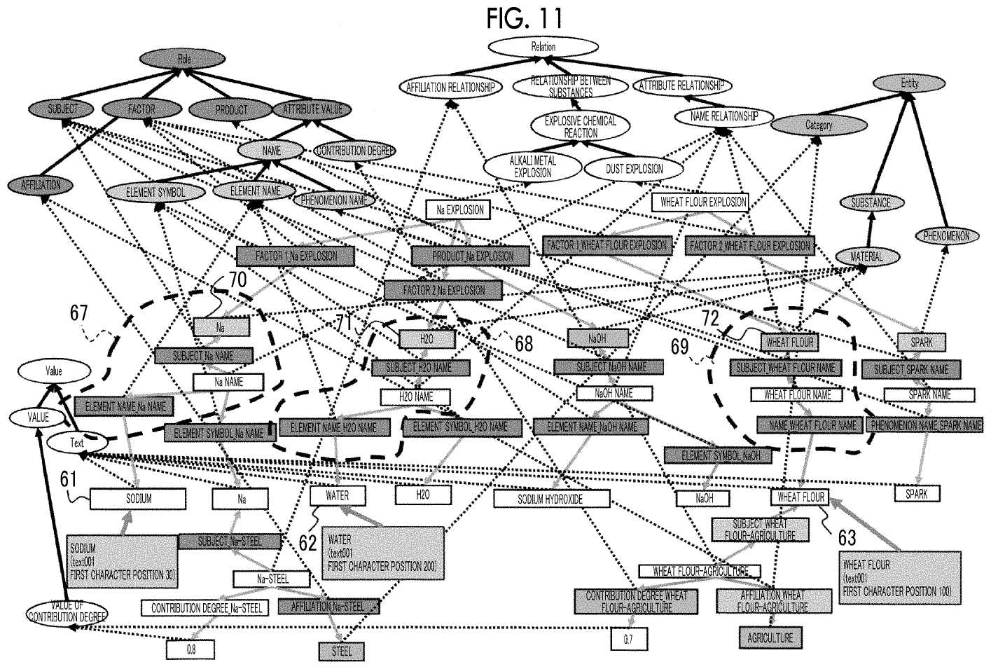

Next, as illustrated by enclosures with broken lines 67, 68, and 69 in FIG. 11, the KG extraction processing unit 15 extracts entities (referred to as “instances”) positioned between entities “Na” 70, “H2O” 71, and “wheat flour” 72 and the texts “sodium” 61″, “water” 62, and “wheat flour” 63 including the entities “Na” 70, “H2O” 71, and “wheat flour” 72 linked to “entity (material)”, that is, an entity “material”, designated in the KG extraction method and a link relationship between the instances as entity information (step S182). Accordingly, this process extracts information related to the entity “material”.

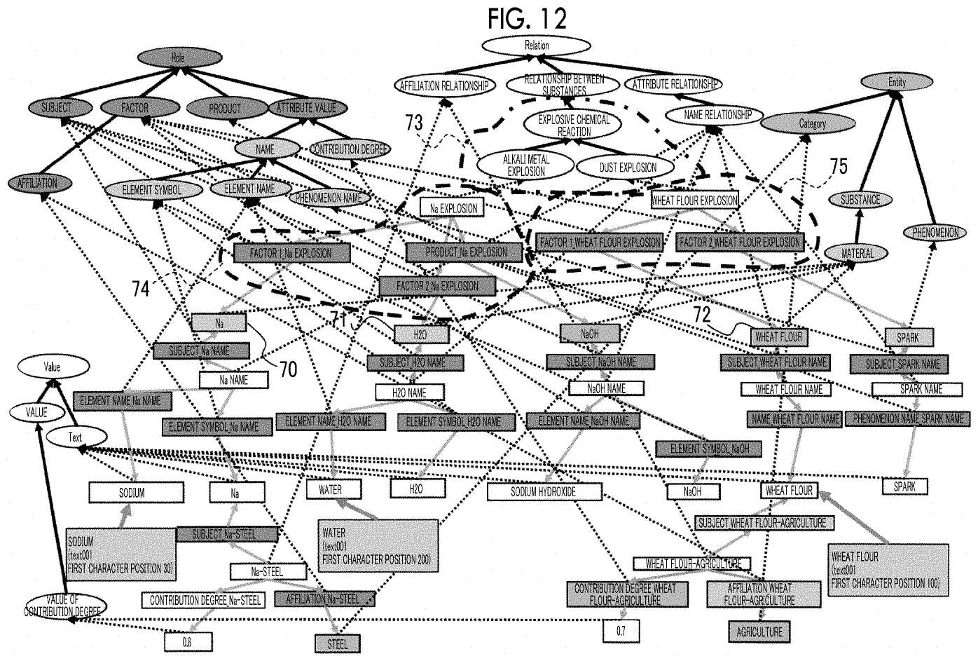

Next, as illustrated by enclosures with broken lines 73, 74, and 75 in FIG. 12, the KG extraction processing unit 15 extracts “relation “explosive chemical reaction”” designated in the KG extraction method and detailed information (referred to as a class) linked thereto, that is, “explosive chemical reaction”, “alkali metal explosion”, and “dust explosion”, entities (referred to as “instances”) positioned between the classes and the entities “Na” 70 “H2O” 71, and “wheat flour” 72 extracted in step S182, and a link relationship between the instances as relation information (step S183). This process extracts a relationship of the information (that is, the entity) extracted in step S182.

Materials may have various representations in a case where the materials are described using text strings. For example, a material “sodium” has a representation “Na” different from“sodium”. Therefore, the extraction may extend to representations other than the text “sodium”.

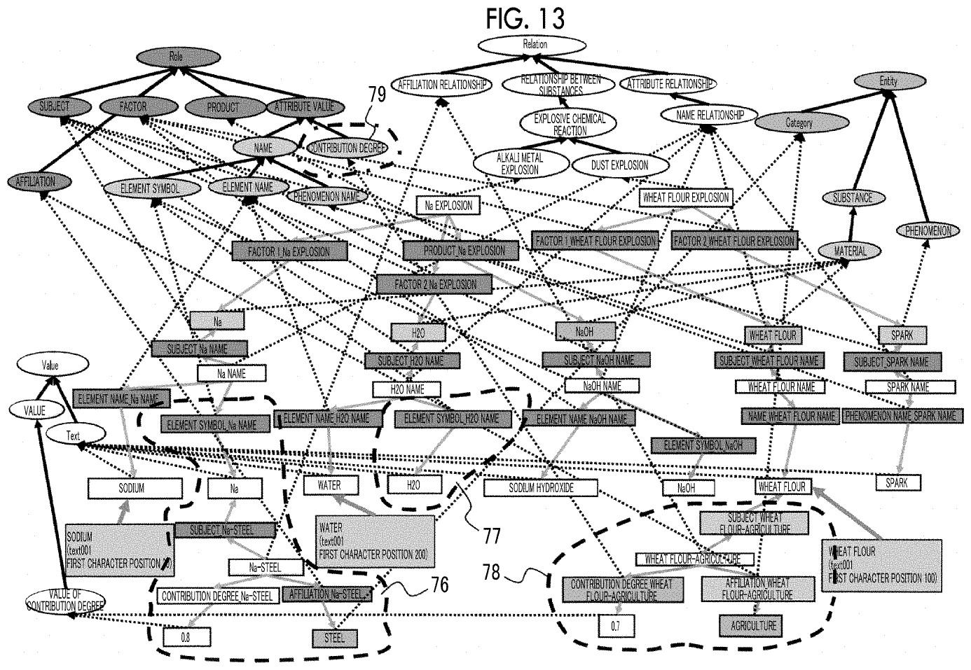

That is, the KG extraction processing unit 15 extends information to be extracted as illustrated by enclosures with broken lines 76, 77, and 78 in FIG. 13. For example, in the case of the material “Na”, information related to “element name Na name” linked to already extracted “Na name” is already extracted in step S183. However, information related to “element symbol Na name” linked to “Na name” is not extracted yet. Therefore, the KG extraction processing unit 15 extracts the information related to “element symbol Na name” as entity extension information (step S184). The entity extension information is extracted in the same manner as the materials “H2O” and “wheat flour”.

In the present exemplary embodiment, a contribution degree of material linked to the role is also presented as information. Thus, an entity “contribution degree” 79 is also extracted.

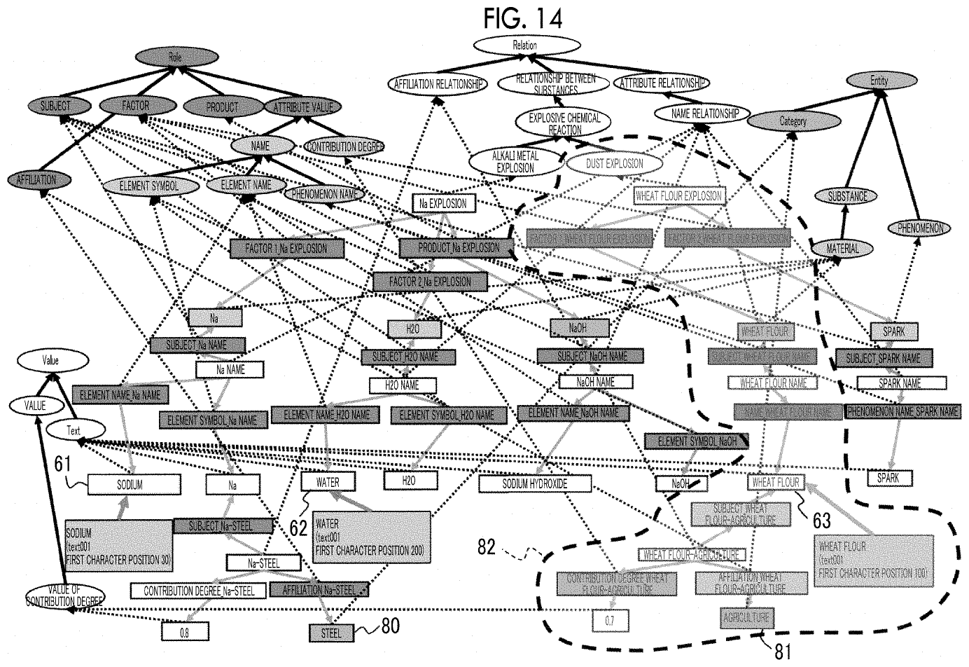

The KG extraction processing unit 15 extracts candidates of information to be presented to the user in the above manner and also deletes information not necessary for the user. That is, while, in step S130, the category label is assigned to each single word extracted in step S120, the KG extraction processing unit 15 deletes information related to a category not assigned to each single word. Specifically, as illustrated in FIG. 6, the user designates “steel” in the user information as the category in which the user does not have knowledge. The single words, that is, texts, “sodium” 61 and “water” 62 extracted from the target document are linked to a category “steel” 80 designated by the user. However, “wheat flour” 63 is linked to a category “agriculture” 81 and is not linked to “steel” 80. Therefore, the KG extraction processing unit 15 does not extract information belonging to the irrelevant category in the information extracted in steps S181 to S184. In FIG. 14, information that falls in the range enclosed by a broken line 82 is excluded from the extraction target and is deleted (step S185). The deletion of information is referred to as “filtering”.

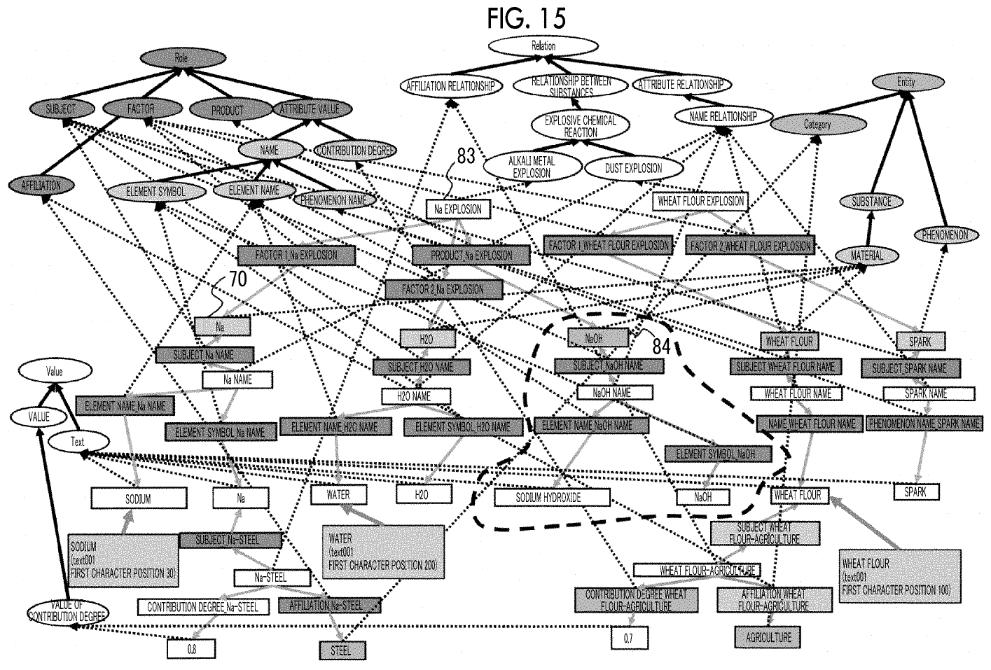

In the relation information extraction process in step S183, entities (referred to as “nodes”) positioned between an entity “Na explosion” 83 linked to alkali metal explosion and the entity “Na” 70 are extracted. However, as illustrated in FIG. 15, an entity of material such as “NaOH” 84 that is not a single word extracted from the target document and thus, is not extracted in the above process is also linked to “Na explosion” 83. Therefore, the KG extraction processing unit 15 extracts “NaOH” 84 and information linked to “NaOH” 84 as relation extension information (step S186).

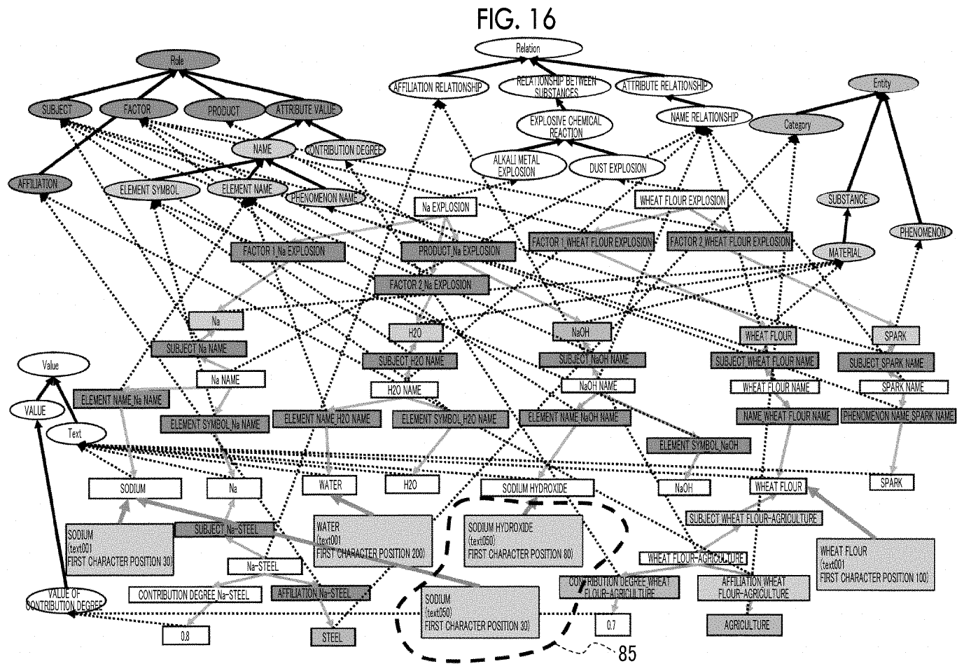

In the above manner, the KG extraction processing unit 15 extracts information to be presented to the user based on the single word set+category label 52 including the single words extracted from the target document. Furthermore, in the present exemplary embodiment, the single word set+category label 56 is generated from the reference document. Therefore, as illustrated by an enclosure with a broken line 85 in FIG. 16, the KG extraction processing unit 15 also includes the single word set obtained from the reference document in the knowledge information to be presented to the user as information related to the target document (step S187). For example, information included in the knowledge information to be presented to the user may be limited to a single word set that may be linked to the extracted texts (“sodium”, “sodium hydroxide” and the like).

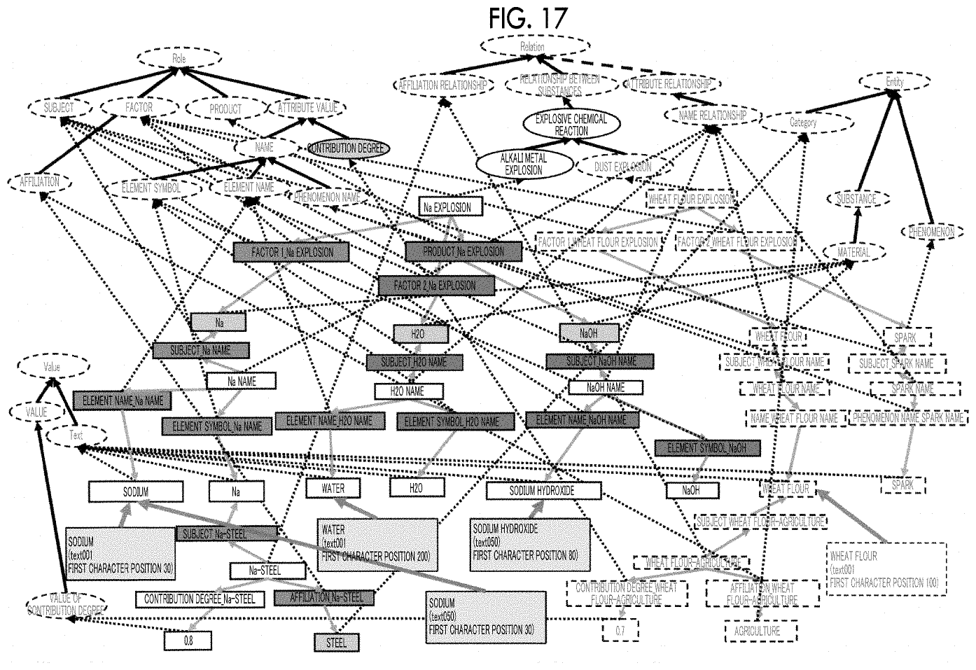

FIG. 17 is a conceptual diagram illustrating information extracted as the knowledge information from all knowledge bases of the knowledge graph illustrated in FIG. 9 by the KG extraction process. In FIG. 17, an entity of a concept that is not extracted as the knowledge information in the KG extraction process (step S180) is represented by a broken line and a thin text.

The knowledge information generated in the above manner is knowledge related to “presentation of explosive chemical reactions between materials” having the highest priority. While the knowledge information to be presented to the user may be generated using only the KG extraction method having the highest priority, the knowledge information may be generated for other priorities and merged into the knowledge information illustrated in FIG. 17. Alternatively, the user may be asked whether only the knowledge information based on the KG extraction method having the highest priority is enough. In a case where presentation of more information is requested, the knowledge information based on a low priority may be generated.

The presentation processing unit 16 presents the knowledge graph, that is, the knowledge information, extracted from the knowledge graph 3 in the above manner to the user (step S190). For example, the knowledge information may be transmitted to a terminal device used by the user and displayed on the terminal device. The user may further understand the professional book designated as the target document by referring to the presented knowledge information.

FIG. 17 is one example of the knowledge information displayed on the terminal device. That is, the whole conceptual knowledge graph (knowledge base DB1) may be displayed such that the extracted knowledge information may be identified from the knowledge graph. For example, as illustrated in FIG. 17, entities of information not corresponding to the knowledge information may be displayed by a broken line and a thin text. Alternatively, only the extracted knowledge information may be presented.

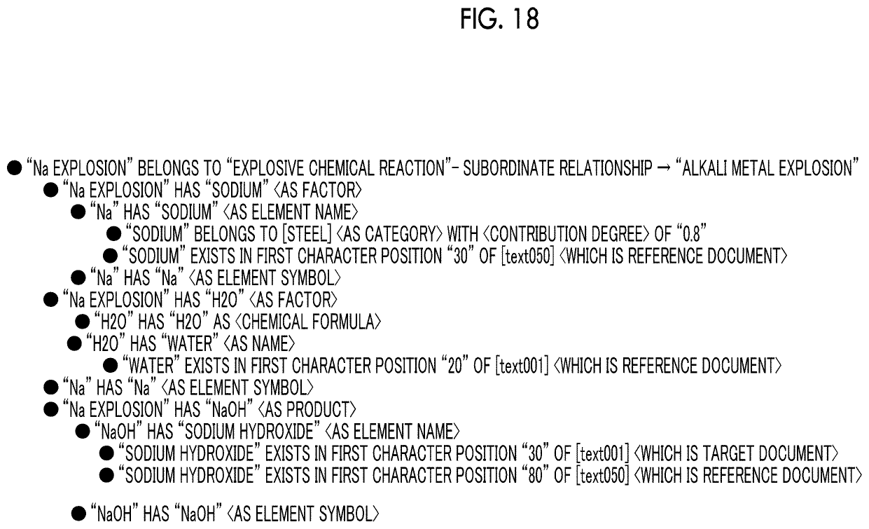

The presentation processing unit 16 is not limited to a presentation method of presenting the knowledge information in a graph format as illustrated in FIG. 17. For example, FIG. 18 is a diagram representing the knowledge information illustrated in FIG. 17 in a sentence format. The presentation processing unit 16 automatically forms sentences by interpreting the relationship between concepts and the hierarchical relationship between concepts illustrated in FIG. 17.

In the sentence format illustrated in FIG. 18, the hierarchical relationship between concepts is represented by indentation. That is, by forming the sentences, the relation (relationship) and the hierarchical relationship between concepts may be represented in a visually recognizable and easily understandable manner. A display of a row positioned in a lower layer may be collapsed and not displayed in a case where, for example, a “black circle” in a row at a higher position of the hierarchical relationship is clicked. In addition, the non-display row positioned in the lower layer may be expanded and displayed by clicking the “black circle”.

In addition, for example, the type of information may be displayed in an easily identifiable manner by changing a display form such as differentiating a display color depending on the type of concept and the type of document such as the target document and the reference document.

While FIG. 18 illustrates an example of a state where the knowledge information is expanded, for example, the range of presentation may be limited depending on a user operation. In the following description, it is assumed that the presentation processing unit 16 functions as a section controlling the display of the terminal device used by the user, and corresponding information is extracted and displayed from the knowledge information in the sentence format depending on the user operation from the terminal device.

For example, the presentation processing unit 16 displays the target document on the terminal device. In the above example, in a case where single words (hereinafter, “target single words”) such as “sodium” and “water” as a presentation target of knowledge in the knowledge information are displayed on the screen, the target single words are displayed as selectable single words. For example, the target single words are displayed in a selectable manner by changing the display form of the target single words from the display forms of other single words such as changing the display color of the target single words or underlining the target single words.

In a case where the user selects any target single word, information related to the selected target single word is extracted from the knowledge information illustrated in FIG. 18 and displayed. The user explicitly selects the target single word. Thus, the knowledge information to be displayed may be displayed in an overlaid manner on the target document.

As another example, the presentation processing unit 16 displays the target document on the terminal device. In a case where the target single word is displayed on the screen by the user scrolling the target document, the presentation processing unit 16 extracts information related to the target word displayed on the screen from the knowledge information illustrated in FIG. 18 and displays the information. The user does not know the target single word as a display target of the knowledge information. Thus, for example, the knowledge information to be displayed is desirably displayed in a non-overlaid manner on the target document in order to check the target single word. At this point, the target single word may be displayed by changing the display form of the target single word from the display forms of other words in order to inform the user of the target single word.

While the user operation is considered as a user operation using the mouse in the above description, the user operation is not for limitation purposes. For example, an augmented reality (AR) technology is used. In a case where the user points at the target single word, information related to the target single word is extracted and displayed near the pointed target single word. Alternatively, in a case where the user seeing the target single word is detected, information related to the target single word may be extracted and displayed near the seen target single word.

The knowledge information to be displayed on the screen may be displayed such that information positioned in the lower layer is not displayed and information in the higher layer is displayed as described above, or information positioned in the lower layer is expanded from the beginning.

In addition, while the target document is the processing target in the above description, other documents such as the reference document may be the processing target.

While one target document is set as a generation target of the knowledge information in the above description, plural documents may be collectively set as the generation target. This process corresponds to a modification example of step S110 illustrated in FIG. 3.

For example, a target document selection processing section is disposed. The target document selection processing section displays a document content screen and a document selection list screen on the terminal device. Document names of documents designated by the user are displayed in a desired order of reading on the document selection list screen. The display order of the document name list displayed on the document selection list screen may be switched by a predetermined operation. The content of the document selected to be read by the user from the list displayed on the document selection list screen is displayed on the document content screen.

In addition, on the document selection list screen, the document name of the document of which the content is displayed on the document content screen, that is, the currently read document, is displayed in a first color (for example, red), and the document name (document name displayed immediately below the document name of the currently read document) of the subsequently read document is displayed in a second color (for example, yellow). In addition, in a case where a document that is read immediately previously to the currently read document is present, the document name (document name displayed immediately above the document name of the currently read document) of the document is displayed in a third color (for example, gray).

The terminal device of the user further displays a display screen of the knowledge information. In a case where the knowledge information is generated using the currently read document as the target document, the presentation processing unit 16 displays the knowledge information in the sentence format or the graph format. In the case of displaying the knowledge information in the sentence format, the knowledge information related to the target single word selected by the user may be displayed, or the corresponding knowledge information may be displayed in response to a scroll operation as described above. The same applies to the following description.

In a case where the user selects a “subsequent document” button displayed on the screen, the document name of the document to be subsequently read is displayed in red, and the document name of the read document is switched to a gray display. In addition, the document name displayed immediately below the document name displayed in red is displayed in yellow. The target document selection processing section displays the content of the new document selected as the currently read document on the document content screen. In addition, the presentation processing unit 16 displays the knowledge information generated for the new document as the target document on the display screen of the knowledge information.

While the knowledge information may be generated using one document selected as the currently read document from the document name list as the target document as described above, plural documents may be handled as the target document.

For example, while the immediately previously read document, the currently read document, and the document to be subsequently read are identifiable from each other by color in the above description, these three documents may be collectively set as the target document. That is, the document-related KG generation processing unit 1 generates the knowledge information using three documents including the currently read document and the immediately previous and subsequent documents as the target document. The document-related KG generation processing unit 1 generates one knowledge information by unifying the three documents.

While the target document is selected by designating the currently read document and the immediately previous and subsequent documents, that is, each one document immediately previous and immediately subsequent to the currently read document, that is, a range of ±1 from the currently read document, the number of target documents may be adjusted by appropriately setting the range.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a segment obtaining section that obtains a segment described in a document designated by a user;
an extraction condition obtaining section that obtains an extraction condition for extracting information including a concept related to the segment as knowledge information from a concept structure information storage section storing concept structure information in which concepts representing events and relationships related to knowledge are related to each other in a hierarchical structure;
a specifying section that specifies a storage location of the knowledge information in the concept structure information storage section and an extraction method for the concept included in the knowledge information from a designated content of the extraction condition;
an extraction section that extracts the knowledge information in accordance with the specified extraction method from the storage location specified by the specifying section; and
a presentation section that presents the knowledge information to the user.

2. The information processing apparatus according to claim 1, further comprising:
a section that obtains knowledge association information in which a candidate of the extraction condition is associated with the extraction method for the knowledge information; and
a section that obtains knowledge information extraction information in which the extraction method for the knowledge information is associated with the storage location of the knowledge information as an extraction target of the extraction method,
wherein the specifying section specifies the storage location in the concept structure information storage section and the extraction method for the knowledge information specified from an item value of each item set in the extraction condition by referring to the knowledge association information and the knowledge information extraction information.

3. The information processing apparatus according to claim 1,
wherein in a case where a plurality of knowledge bases are stored in the concept structure information storage section, the specifying section specifies a knowledge base as the storage location of the knowledge information by referring to the knowledge information extraction information.

4. The information processing apparatus according to claim 1,
wherein the extraction section extracts the concept included in the knowledge information depending on a semantic relationship between concepts included in the concept structure information storage section.

5. The information processing apparatus according to claim 4,
wherein the semantic relationship includes at least one of a meaning of the concept, a relationship between concepts, or a role of the concept in the relationship between concepts.

6. The information processing apparatus according to claim 1, further comprising:
a category linking section that links a category to which the segment belongs to each segment obtained by the segment obtaining section by referring to a category information storage section storing category information in which the segment is associated with the category in advance.

7. The information processing apparatus according to claim 6,
wherein in a case where a category of the knowledge information that the user desires to obtain is set in the extraction condition, the extraction section extracts only the knowledge information related to the segment linked to the category set in the extraction condition.

8. The information processing apparatus according to claim 6,
wherein in a case where a category of the knowledge information that the user desires to obtain is set in the extraction condition, the extraction section does not extract the knowledge information related to the segment not linked to the category set in the extraction condition.

9. The information processing apparatus according to claim 1,
wherein the presentation section presents the knowledge information in a graph format.

10. The information processing apparatus according to claim 1,
wherein the presentation section presents the concept structure information such that the knowledge information extracted from the concept structure information is determinable.

11. The information processing apparatus according to claim 1,
wherein the presentation section presents the knowledge information in a sentence format.

12. The information processing apparatus according to claim 1,
wherein the presentation section presents the knowledge information such that a hierarchical relationship between concepts indicated by the knowledge information is visually recognizable.

13. A non-transitory computer readable medium storing a program causing a computer to function as:
a segment obtaining section that obtains a segment described in a document designated by a user;
an extraction condition obtaining section that obtains an extraction condition for extracting information including a concept related to the segment as knowledge information from a concept structure information storage section storing concept structure information in which concepts representing events and relationships related to knowledge are related to each other in a hierarchical structure;
a specifying section that specifies a storage location of the knowledge information in the concept structure information storage section and an extraction method for the concept included in the knowledge information from a designated content of the extraction condition;
an extraction section that extracts the knowledge information in accordance with the specified extraction method from the storage location specified by the specifying section; and
a presentation section that presents the knowledge information to the user.

14. An information processing apparatus comprising:
segment obtaining means for obtaining a segment described in a document designated by a user;
extraction condition obtaining means for obtaining an extraction condition for extracting information including a concept related to the segment as knowledge information from concept structure information storage means for storing concept structure information in which concepts representing events and relationships related to knowledge are related to each other in a hierarchical structure;
specifying means for specifying a storage location of the knowledge information in the concept structure information storage means and an extraction method for the concept included in the knowledge information from a designated content of the extraction condition;
extraction means for extracting the knowledge information in accordance with the specified extraction method from the storage location specified by the specifying means; and
presentation means for presenting the knowledge information to the user.
